(19) United States
(12) Patent Application Publication
(10) Pub. No.: US 2025/0256711 A1
(43) Pub. Date: Aug. 14, 2025

(54) VEHICLE CONTROL DEVICE AND STORAGE MEDIUM

(71) Applicant: TOYOTA JIDOSHA KABUSHIKI KAISHA, Toyota-shi (JP)

(72) Inventor: Hikaru AKIMOTO, Mishima-shi (JP)

(73) Assignee: TOYOTA JIDOSHA KABUSHIKI KAISHA, Toyota-shi (JP)

(21) Appl. No.: 18/944,373

(22) Filed: Nov. 12, 2024

(30) Foreign Application Priority Data
Feb. 14, 2024 (JP) 2024-020111

(51) Int. Cl. B60W 30/14

(52) U.S. Cl. CPC B60W 30/143; B60W 2554/4041; B60W 2554/4045; B60W 2554/803; B60W 2720/10

(57) ABSTRACT

The vehicle control device includes a control unit that executes a following traveling control for causing the vehicle to travel following another vehicle traveling in front of the vehicle traveling in the traffic lane, and a constant speed traveling control for causing the vehicle to travel in the traffic lane at a constant speed. The control unit executes the following traveling control for causing the vehicle to travel following the other vehicle based on the detection value for detecting the other vehicle. In a case where the other vehicle recognizes the departure operation of leaving the traffic lane based on the detection value, the control unit determines that the other vehicle leaves the traffic lane. In this case, the following traveling control is stopped and the constant speed traveling control is executed.

### CROSS-REFERENCE TO RELATED APPLICATION

This application claims priority to Japanese Patent Application No. 2024-020111 filed on Feb. 14, 2024, incorporated herein by reference in its entirety.

### BACKGROUND

### 1. Technical Field

The present disclosure relates to a vehicle control device and a storage medium that cause a vehicle to travel by following a preceding another vehicle.

### 2. Description of Related Art

In recent years, driving assistance technology called ACC (Adaptive Cruise Control) has been applied to a vehicle, ACC causes the vehicle to travel by maintaining a set speed and inter-vehicle distance. ACC is used on a high-standard road such as an expressway on which the vehicle is capable of high speed travel. ACC is also used for the vehicle traveling at a low speed at the time of traffic congestion on the high-standard road. ACC may also be used for the vehicle traveling on a general road.

When ACC is used on the general road, there may be cases where another vehicle traveling ahead of an own vehicle that travels in a traffic lane turns left or turns right, and the other vehicle departs the traffic lane. In this case, the own vehicle is unable to capture the other vehicle, and travels at a constant speed by switching to a constant speed traveling control.

For example, Japanese Unexamined Patent Application Publication No. 2005-067423 (JP 2005-067423 A) describes a control method related to a timing to switch to the constant speed traveling control when the preceding other vehicle is unable to be captured at the time of following traveling. The control method described in JP 2005-067423 A captures the preceding other vehicle in a traffic lane that the own vehicle is traveling, and executes a following traveling control. When a predetermined time has elapsed from the timing at which the preceding other vehicle is unable to be captured and there is a predetermined condition, the control method determines that the other vehicle has departed the traffic lane, and switches to the constant speed traveling control.

### SUMMARY

According to the technology described in JP 2005-067423 A, when the own vehicle reaccelerates to a set speed by switching from the following traveling control to the constant speed traveling control, there is a possibility that a delay in the timing of reacceleration is felt by a driver.

The present disclosure can provide a vehicle control device and a storage medium capable of executing speed recovery at an appropriate timing when switching from a following traveling control to a constant speed traveling control.

One aspect of the present disclosure is
a vehicle control device including
a control unit that executes a following traveling control and a constant speed traveling control, the following traveling control causing a vehicle that travels within a traffic lane to travel by following another vehicle that travels in front of the vehicle and the constant speed traveling control causing the vehicle to travel at a constant speed within the traffic lane, in which
the control unit
executes the following traveling control that causes the vehicle to travel by following the other vehicle based on a detection value that detects the other vehicle,
determines that the other vehicle departs the traffic lane when recognizing a departure operation in which the other vehicle departs the traffic lane based on the detection value, and executes the constant speed traveling control along with stopping the following traveling control.

According to the present disclosure, speed recovery can be executed at an appropriate timing when switching from a following traveling control to a constant speed traveling control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle control device according to an embodiment;

FIG. 2 is a diagram illustrating following traveling control;

FIG. 3 is a diagram illustrating an example of a departure operation of another vehicle;

FIG. 4 is a diagram illustrating an example of a departure operation of another vehicle;

FIG. 5 is a diagram for explaining an overlap rate between another vehicle and a vehicle;

FIG. 6 is a diagram for explaining a state in which a traffic lane is changed to a traffic lane where another vehicle and a vehicle adjoin each other; and

FIG. 7 is a flowchart illustrating a flow of processing of the vehicle control method executed in the vehicle control device.

### DETAILED DESCRIPTION OF EMBODIMENTS

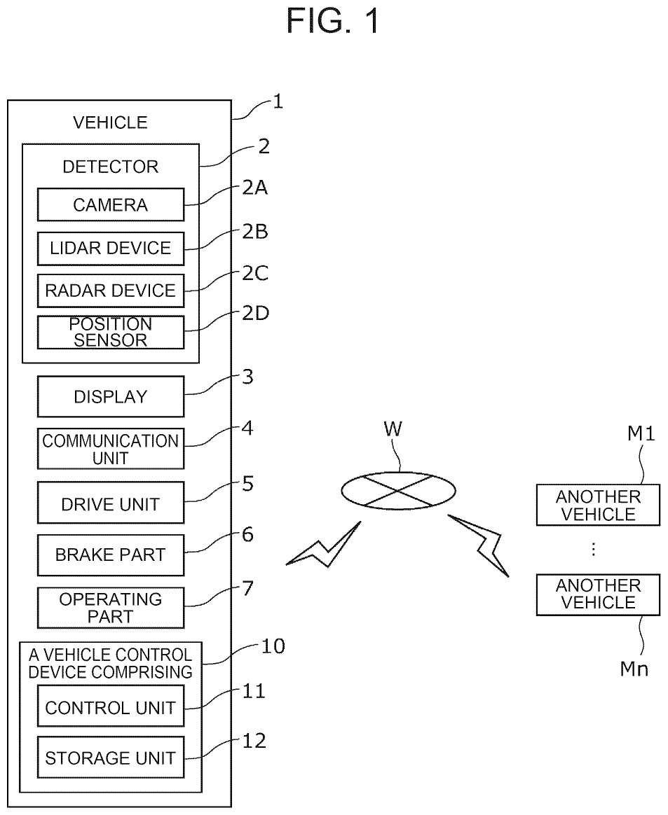

As illustrated in FIG. 1, the vehicle 1 includes, for example, a vehicle control device 10 that executes control related to traveling. The vehicle control device 10 controls the traveling of the vehicle 1 based on the operation of the driver. The vehicle control device 10 executes driving support control such as ACC on the basis of the detection value detected by the detection unit 2 that detects the surrounding environment of the vehicle. The vehicle control device 10 executes following traveling control for causing the vehicle 1 to follow another vehicle traveling ahead of the traffic lane. The vehicle control device 10 switches the following traveling control to execute the constant speed traveling control for causing the vehicle 1 to travel at a constant speed.

For example, the detection unit 2 is configured to detect an environment around the vehicle 1 and output a detection value. The detection unit 2 includes, for example, a camera 2A that captures an image of the surroundings of the vehicle 1. The detection unit 2 may include one or more camera 2A for capturing a predetermined imaging area around the vehicle 1. The camera 2A generates an image of the surroundings of the vehicle 1 and outputs the image to the vehicle control device 10.

The detection unit 2 includes a lidar device 2B that detects an object around the vehicle 1. For example, the lidar device 2B emits the laser beam within the scanning area, and receives the reflected light reflected by the laser beam from the object, thereby acquiring three-dimensional information of the object around the vehicle 1. The lidar device 2B is configured to acquire three-dimensional data of the surroundings of the vehicle 1 in the scanning area of the laser beam. The detection unit 2 includes a radar device 2C that detects an object around the vehicle 1. The radar device 2C detects an object existing around the vehicle 1 by, for example, irradiating a millimeter-wave-stagnated radar wave within a scan area and measuring a reflected wave. The radar device 2C is configured to be able to measure a distance, a velocity, and an angle to an object such as a pedestrian or a vehicle.

The detection unit 2 is provided with a position sensor 2D for measuring the present position of the vehicle 1. The position sensor 2D includes, for example, a GPS (Global Positioning System) sensor. The position sensor 2D may be used, for example, in a navigational device. The position sensor 2D outputs the measurement to the vehicle control device 10.

The vehicle 1 includes a display unit 3 that outputs a display image. The display unit 3 is constituted by a display device such as a liquid crystal display or an organic EL (Electro-Luminescence), for example. The display unit 3 displays, for example, a display image indicating the notification content when the driving support is executed. The display unit 3 may be configured to display the display contents of the navigation device provided in the vehicle 1. The display unit 3 may be constituted by a touch panel.

The display unit 3 may be configured as an input unit that receives an input operation input by a user. In this case, the display unit 3 may display a display image for receiving an input operation. The display unit 3 may be realized by communicating with a portable terminal device such as a smartphone carried by a user.

The vehicle 1 includes a communication unit 4 connectable to a network W. The communication unit 4 is constituted by, for example, a communication device capable of wireless communication. The communication unit 4 may be configured to be able to directly communicate with another vehicle Mn (n: any natural number). Data acquired by communication with another vehicle Mn present around the vehicle 1 is included in the detection value. Mn of another vehicle present in the surroundings of the vehicle 1 obtained from the network W may be included in the detection value. The vehicle 1 includes a drive unit 5 serving as a driving source for traveling. The drive unit 5 may be constituted by an internal combustion engine or an electric motor.

The drive unit 5 may be constituted by a hybrid device in which an internal combustion engine and an electric motor are combined. When the vehicle 1 is a manual driving vehicle, the drive unit 5 is controlled based on an operation by the driver, and under a predetermined condition, the vehicle control device 10 executes driving support control for supporting the operation of the driver. When the vehicle 1 is an autonomous vehicle, the drive unit 5 is controlled by the vehicle control device 10.

The vehicle 1 includes a braking unit 6 for decelerating the vehicle 1. The braking unit 6 is constituted by, for example, a brake device. The braking unit 6 may be configured by the drive unit 5 when the drive unit 5 is configured by an electric motor. In this case, the drive unit 5 may be configured to perform regenerative power generation and decelerate based on the deceleration energy of the vehicle 1. The vehicle 1 includes an operation unit 7 that receives an operation of the driver. The operation unit 7 is constituted by an operation system device such as an accelerator pedal for adjusting an output of the drive unit 5 and a brake pedal for adjusting a braking degree of the braking unit 6. The operation unit 7 outputs, for example, a signal corresponding to the degree of operation of each operation system device to the vehicle control device 10.

The vehicle control device 10 includes a control unit 11 that executes control related to traveling of the vehicle 1, and a storage unit 12 that stores data and programs necessary for the control. The control unit 11 is constituted by a hardware processor such as at least one CPU (Central Processing Unit). The storage unit 12 includes a non-transitory storage medium such as a hard disk drive (HDD) or a solid state disk (SSD). The storage unit 12 may store map data used in the navigation device.

The storage unit 12 stores data of detection values output from the detection unit 2. The data of the detection value may be stored in a predetermined period and then updated with data of a new detection value. The control unit 11 executes a navigation control including an ACC that causes the vehicle 1 to travel while maintaining a set velocity, based on a detection value for detecting the surroundings of the vehicle 1. The control unit 11 switches from the normal mode to the navigation mode based on an input operation of the driver, and executes navigation control. The navigation control includes following traveling control and constant speed traveling control as described later.

The control unit 11 executes navigation control based on a detection value detected by the detection unit 2, which includes, for example, imaging data captured by the camera 2A, data of a measured value of the lidar device 2B, and data of a measured value of the radar device 2C. The control unit 11 executes navigation control based on a combination of one or more detection values among detection values of any of the devices included in the detection unit 2. The combination of one or more detection values is set according to the vehicle type of the vehicle 1.

For example, the control unit 11 executes machine learning such as deep learning in advance using, as teacher data, image data obtained by imaging the surroundings of the vehicle 1 including the other vehicle Mn. The control unit 11 is configured to be able to recognize the behavior of the other vehicle Mn traveling in the traffic lane L in which the vehicle 1 travels, based on the captured image data captured by the camera 2A. The control unit 11 may be configured to be able to recognize the relative velocity and the relative distance of the other vehicle Mn traveling in front of the vehicle 1 on the basis of the imaging data captured by the camera 2A.

The control unit 11 is configured to be able to recognize the relative velocity and the relative distance of the other vehicle Mn traveling in front of the vehicle 1 based on the data of the measurement value of the lidar device 2B that includes the other vehicle Mn and detects the surrounding environment of the vehicle 1 and the data of the measurement value of the radar device 2C. The control unit 11 may recognize the relative velocity and the relative distance of the other vehicle Mn based on a combination of one or more detection values among any detection values including the imaging data captured by the camera 2A, the data of the measurement value of the lidar device 2B, and the data of the measurement value of the radar device 2C.

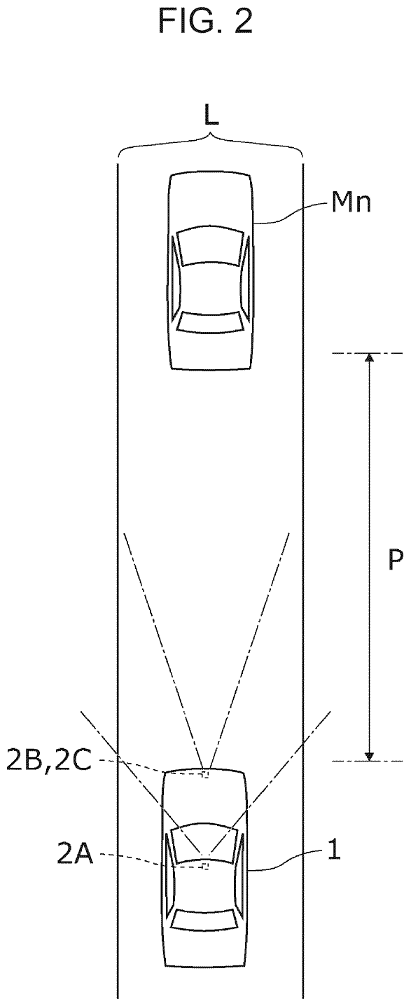

FIG. 2 schematically illustrates the following traveling control of the vehicle 1. The control unit 11 causes the vehicle 1 to travel following the other vehicle Mn traveling in front of the vehicle 1 traveling in the traffic lane L in the following traveling control. The control unit 11 acquires a detection value by the detection unit 2. The control unit 11 acquires a detection value detected by the detection unit 2, which includes the imaging data captured by the camera 2A, the data of the measurement value of the lidar device 2B, and the data of the measurement value of the radar device 2C. The control unit 11 determines whether or not another vehicle Mn is present within a predetermined distance P ahead of the vehicle 1 based on the detection value. The predetermined distance P is set in accordance with the speed of the vehicle 1. The predetermined distance P is set so that the distance becomes longer in proportion to the speed of the vehicle 1.

When determining that there is no another vehicle Mn within the predetermined distance P ahead of the vehicle 1, the control unit 11 executes constant speed traveling control for causing the vehicle 1 to travel in the traffic lane at a constant speed. In the constant speed traveling control, the control unit 11 controls the drive unit 5 and the braking unit 6 to maintain the speed of the constant speed set value and cause the vehicle 1 to travel. The constant speed setting value is set in accordance with an input operation of the user.

When determining that the other vehicle Mn is present within the predetermined distance P in front of the vehicle 1 based on the detection value for detecting the other vehicle Mn, the control unit 11 executes the following traveling control for causing the vehicle 1 to travel following the other vehicle Mn. The control unit 11 controls the drive unit 5 and the braking unit 6 so that the inter-vehicle distance between the vehicle 1 and the other vehicle Mn becomes the inter-vehicle setting value, and adjusts the inter-vehicle distance between the vehicle 1 and the other vehicle Mn. The inter-vehicle setting value is set to a plurality of stepwise distance values, for example. The inter-vehicle setting value is gradually increased or decreased in accordance with a user's selection operation. The inter-vehicle setting value may be set to an arbitrary distance value. The inter-vehicle setting value may be automatically adjusted by the control unit 11 in accordance with the speed of the vehicle 1.

When the speed of the preceding other vehicle Mn decreases, the control unit 11 decelerates the vehicle 1 and maintains the inter-vehicle distance between the vehicle 1 and the other vehicle Mn at the set value. When the velocity of the preceding other vehicle Mn is increased, the control unit 11 accelerates the vehicle 1 and maintains the inter-vehicle distance between the vehicle 1 and the other vehicle Mn at the set value. When the speed of the preceding other vehicle Mn decreases, the control unit 11 decelerates the vehicle 1 and maintains the inter-vehicle distance between the vehicle 1 and the other vehicle Mn at the set value. When the speed of the preceding other vehicle Mn is increased to a reference value or more, the control unit 11 performs constant speed traveling control of accelerating the vehicle 1 to an upper limit value of the speed and causing the vehicle 1 to travel in the traffic lane L at a constant speed.

The control unit 11 determines whether or not the other vehicle leaves the traffic lane while the following traveling control is being executed. The control unit 11 determines that the other vehicle Mn leaves the traffic lane L when the other vehicle Mn recognizes the departure operation of leaving the traffic lane L on the basis of the detection value for detecting the other vehicle Mn while the following traveling control is being executed. The departure operation includes a state in which it is estimated that the other vehicle Mn starts leaving the traffic lane L, and a state in which it is estimated that it is in the middle of leaving the traffic lane L. The control unit 11 determines whether or not the other vehicle Mn is performing a departure operation for leaving the traffic lane L based on the detection value.

The control unit 11 determines that the other vehicle Mn leaves the traffic lane when any one or more of the plurality of departure operations described below is recognized. The control unit 11 determines that the other vehicle Mn leaves the traffic lane on the basis of the combination of the one or more departure operations to be recognized. When it is determined that the other vehicle Mn leaves the traffic lane L, the control unit 11 stops the following traveling control and executes the constant speed traveling control.

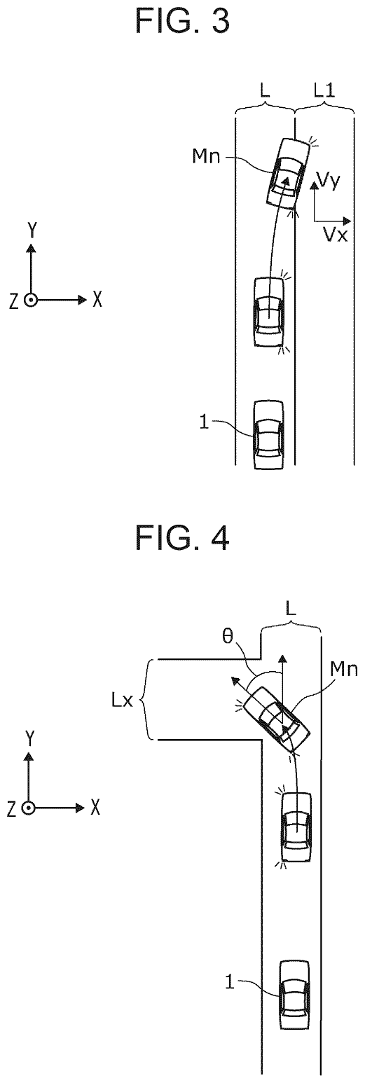

FIG. 3 illustrates a situation in which the other vehicle Mn changes the traffic lane from the traffic lane L to the adjacent traffic lane L1. In the illustrated embodiment, the adjacent traffic lane L1 is shown adjacent to the right side of the traffic lane L. The adjacent traffic lane L1 may be adjacent to the left side of the traffic lane L. When determining whether or not the other vehicle Mn leaves the traffic lane, the control unit 11 determines whether or not the direction indicator provided in the vehicle 1 is in a non-lighting state.

When the direction indicator provided in the vehicle 1 is turned on, the control unit 11 continues the following traveling control because there is a possibility that the vehicle 1 itself leaves the traffic lane L. The control unit 11 determines that the other vehicle Mn is performing the departure operation of leaving the traffic lane L when the direction indicator provided in the vehicle 1 is in a non-lighting state and the lateral movement speed Vx of the other vehicle Mn relative to the vehicle 1 is equal to or greater than the threshold.

The lateral movement speed Vx is a speed component of the vehicle 1 along a direction (X-axis direction in the drawing) perpendicular to the traveling direction (Y-axis direction in the drawing) of the traffic lane L. The threshold of the lateral movement speed Vx is set to a predetermined value in advance. At this time, the control unit 11 may recognize that the directional indicator of the other vehicle Mn is turned on and that the lateral movement speed Vx of the other vehicle Mn relative to the vehicle 1 is equal to or greater than the threshold. In this case, it may be determined that the other vehicle Mn is performing a departure operation of leaving the traffic lane L. This is because the turning-on status of the direction indicator of the other vehicle Mn increases the possibility that the other vehicle Mn leaves the traffic lane L.

When the control unit 11 determines that the other vehicle Mn is performing the departure operation of leaving the traffic lane L, it determines that the other vehicle leaves the traffic lane. The control unit 11 may not recognize that the other vehicle Mn completely leaves the traffic lane L and shifts to the adjacent traffic lane L1, and may recognize the process of leaving the traffic lane L. After that, when the control unit 11 recognizes that the other vehicle Mn has left the traffic lane on the basis of the detection value, it stops the following traveling control and executes the constant speed traveling control. When the control unit 11 recognizes that the other vehicle Mn returns to the traffic lane on the basis of the detection value, the following traveling control is continued.

At this time, when the vehicle 1 is traveling at a speed equal to or lower than the set speed, the control unit 11 accelerates the vehicle 1 again to the set speed, maintains the set speed, and causes the vehicle 1 to travel. Thus, when switching from the following traveling control to the constant speed traveling control, the control unit 11 can re-accelerate to the set speed without causing the driver to feel a delay in the timing of re-acceleration.

FIG. 4 illustrates a situation in which the other vehicle Mn turns left in a traffic lane Lx intersecting the traffic lane L. When the other vehicle Mn turns left from the traffic lane L, the yaw angle θ of the other vehicle Mn relative to the vehicle 1 is increased. The control unit 11 calculates the yaw angle θ of the other vehicle Mn relative to the vehicle 1 based on the images of the other vehicle Mn captured in the captured image data. When the yaw angle θ of the other vehicle Mn relative to the vehicle 1 is increasing, the control unit 11 recognizes that the other vehicle Mn is performing a departure operation for leaving the traffic lane L.

At this time, when the control unit 11 recognizes that the yaw angle θ of the other vehicle Mn relative to the vehicle 1 is increasing and the direction indicator of the other vehicle Mn is turned on, it may determine that the other vehicle Mn is performing the departure operation of leaving the traffic lane L. The control unit 11 compares the yaw angle θ of the other vehicle Mn relative to the vehicle 1 with the thresholds of the yaw angle θ set in advance, while the direction indicator provided in the vehicle 1 is in the non-lighting state. When the yaw angle θ of the other vehicle Mn relative to the vehicle 1 is equal to or larger than the threshold value, the control unit 11 determines that the other vehicle Mn leaves the traffic lane L.

After that, when the control unit 11 recognizes that the other vehicle Mn turns left and leaves the traffic lane L based on the detection value, the following traveling control is stopped and the constant speed traveling control is executed. When the control unit 11 recognizes that the other vehicle Mn returns to the traffic lane on the basis of the detection value, the following traveling control is continued. Although the above process exemplifies a state in which the other vehicle Mn turns left, the process may be applied to a state in which the other vehicle Mn turns right. When recognizing that the other vehicle Mn turns right and leaves the traffic lane L on the basis of the detection value of the yaw angle θ of the other vehicle Mn relative to the vehicle 1, the control unit 11 stops the following traveling control and executes the constant speed traveling control.

The control unit 11 may recognize the departure operation of leaving the traffic lane L of the other vehicle Mn based on not only the relative yaw angle of the other vehicle Mn with respect to the vehicle 1 but also the relative lateral movement acceleration of the other vehicle Mn with respect to the vehicle 1. It is estimated that the other vehicle Mn is accelerated after turning left or right in the traffic lane Lx where the other vehicle Mn intersects with the traffic lane L within a predetermined distance from the connecting point of the traffic lane Lx.

The control unit 11 recognizes that, when the lateral movement acceleration of the other vehicle Mn with respect to the vehicle 1 is equal to or greater than a threshold value within a predetermined lateral distance range with respect to the vehicle 1, the other vehicle Mn turns left or right, and performs a departure operation of leaving the traffic lane L. When recognizing that the other vehicle Mn turns right and leaves the traffic lane L on the basis of the detection value of the lateral movement acceleration of the other vehicle Mn with respect to the vehicle 1, the control unit 11 stops the following traveling control and executes the constant speed traveling control.

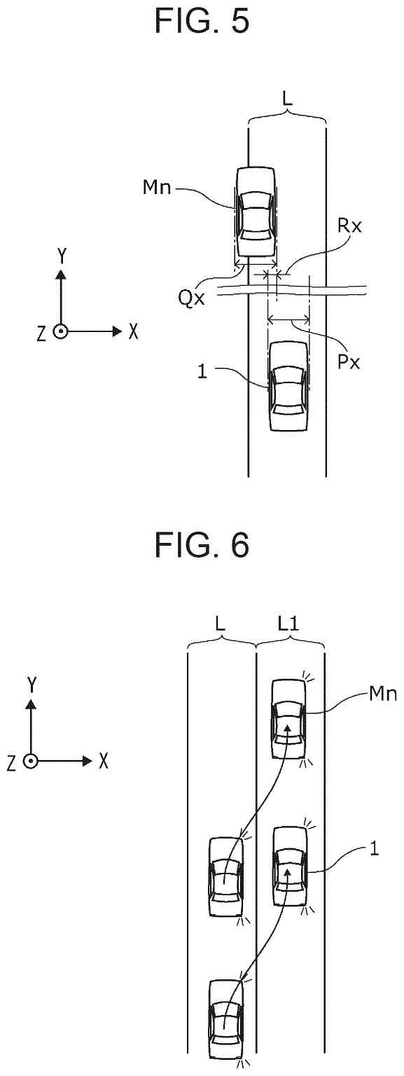

FIG. 5 shows the relative lateral positional relation between the other vehicle Mn and the vehicle 1. The control unit 11 may recognize the departure operation of the other vehicle Mn based on the relative lateral positional relation between the other vehicle Mn and the vehicle 1. The control unit 11 calculates, for example, an overlap rate indicating a relative lateral positional relation between the other vehicle Mn and the vehicle 1. The overlap rate is calculated, for example, by dividing the overlap distance Rx by the vehicle body width Px of the vehicle 1 (Rx/Px), when there is an overlap distance Rx in which the vehicle body width Px of the vehicle 1 overlaps with the vehicle body width Qx of another vehicle Mn in the lateral positional relation in the traffic lane L. If there is no overlap distance Rx, the overlap rate is set to 0.

The control unit 11 compares the calculated overlap rate with the threshold value, and when the overlap rate is equal to or less than the threshold value, determines that the other vehicle Mn is performing a departure operation for leaving the traffic lane L. When the overlap rate is decreased to 0, the control unit 11 determines that the other vehicle Mn has left the traffic lane L, and stops the following traveling control and executes the constant speed traveling control.

When the other vehicle Mn stops on the road shoulder without leaving the traffic lane L, the control unit 11 may assume that the other vehicle Mn has left the traffic lane L, and may stop the following traveling control and execute the constant speed traveling control. The control unit 11 stops the following traveling control and executes the constant speed traveling control when the light display for decelerating the other vehicle Mn is turned on and when the stop of the other vehicle Mn is recognized. The light display for decelerating includes a lighting state of the brake lamp and a blinking state of the hazard lamp.

When the control unit 11 recognizes a stopping factor for stopping the other vehicle Mn in the traffic lane L on the basis of the detection value, the control unit continues the following traveling control to decelerate and stop the vehicle following the other vehicle. The stopping factors include the presence of a light display for decelerating, a decrease in the velocity of the other vehicle Mn, the presence of a signage associated with the stopping, the presence of a sign associated with the stopping, the presence of a vehicle stopped at the end of the congestion train, and other conditions in which it is presumed that other vehicle Mn may be stopped.

FIG. 6 illustrates a situation in which the other vehicle Mn and the vehicle 1 change traffic lanes to the traffic lane L1 adjacent to the traffic lane L. For example, even when the other vehicle changes the route and recognizes the departure operation, the following traveling control may be continued when the vehicle 1 travels on the same route as the other vehicle Mn and continuously travels behind the other vehicle Mn. In a case where the control unit 11 recognizes the departure operation the traffic lane L of the other vehicle Mn, when it is determined that the lighting indicator of the light display of the vehicle 1 is turned on and that the vehicle 1 follows the other vehicle Mn and travels on the route, the following traveling control is continued.

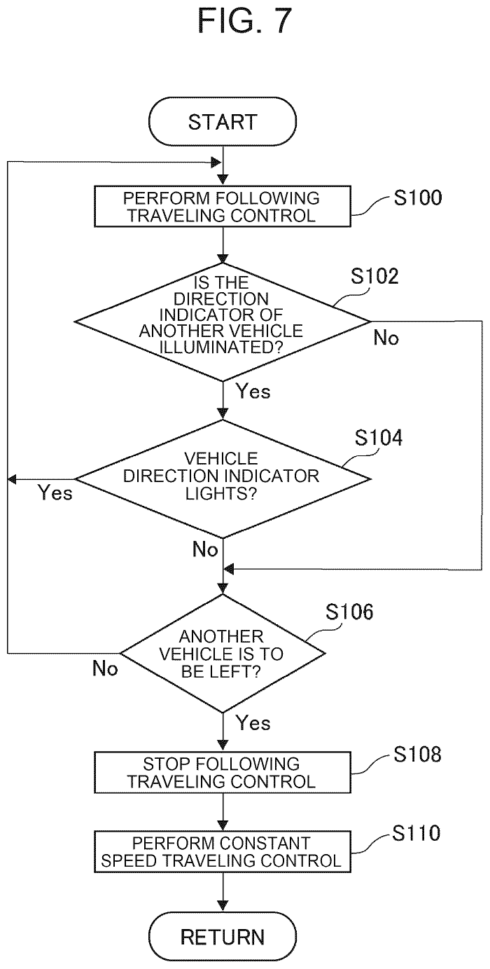

FIG. 7 shows a flow of processing of the vehicle control method executed in the vehicle control device 10. The vehicle control method includes a following traveling control for causing the vehicle 1 to travel following the other vehicle Mn traveling in front of the vehicle 1 traveling in the traffic lane L, and a constant speed traveling control for causing the vehicle 1 to travel in the traffic lane L at a constant speed. The vehicle control method is executed by a computer program installed in a computer installed in the vehicle control device 10. The computer program causes the vehicle control device 10 to execute the following processes.

The control unit 11 executes the following traveling control for causing the vehicle 1 to travel following the other vehicle Mn based on the detection value for detecting the other vehicle Mn (S100). The control unit 11 determines whether or not the direction indicator of the other vehicle Mn is turned on based on the detection value (S102). When the direction indicator of the other vehicle Mn is not turned on, the control unit 11 advances the process to S106. When the direction indicator of the other vehicle Mn is lit, the control unit 11 determines whether or not the direction indicator of the vehicle 1 is lit (S104).

When the direction indicator of the vehicle 1 is on, the control unit 11 returns the process to S100. When the direction indicator of the vehicle 1 is not lit, the control unit 11 determines whether or not the other vehicle Mn leaves the traffic lane L (S106). When the other vehicle recognizes the departure operation of leaving the traffic lane, the control unit 11 determines that the other vehicle leaves the traffic lane, and stops the following traveling control (S108). The control unit 11 executes constant speed traveling control to cause the vehicle 1 to travel at a constant speed in the traffic lane L (S110).

As described above, according to the vehicle control device 10, it is possible to execute the speed recovery when switching from the following traveling control to the constant speed traveling control at an appropriate timing. According to the vehicle control device 10, by recognizing the departure operation of the other vehicle Mn, it is possible to suppress the driver from feeling a delay in re-acceleration by switching from the following traveling control to the constant speed traveling control. According to the vehicle control device 10, the following traveling control can be continued by recognizing a stopping factor in which the other vehicle Mn is stopped.

In the above-described embodiment, the computer program executed in the configuration of the vehicle control device 10 may be provided in a form recorded in a non-transitory computer-readable non-transitory recording medium (a storage medium). A non-transitory computer-readable non-transitory recording medium is, for example, a semiconductor memory, a magnetic recording medium, or an optical recording medium.

What is claimed is:

1. A vehicle control device comprising a control unit that executes a following traveling control and a constant speed traveling control, the following traveling control causing a vehicle that travels within a traffic lane to travel by following another vehicle that travels in front of the vehicle and the constant speed traveling control causing the vehicle to travel at a constant speed within the traffic lane, wherein the control unit
executes the following traveling control that causes the vehicle to travel by following the other vehicle based on a detection value that detects the other vehicle,
determines that the other vehicle departs the traffic lane when recognizing a departure operation in which the other vehicle departs the traffic lane based on the detection value, and
executes the constant speed traveling control along with stopping the following traveling control.

2. The vehicle control device according to claim 1, wherein in a state in which a direction indicator provided in the vehicle is not lit, the control unit determines that the other vehicle has departed the traffic lane when recognizing the departure operation of any one of the following departure operations:
a state in which a direction indicator of the other vehicle is lit;
a state in which a relative lateral movement speed of the other vehicle with respect to the vehicle is equal to or more than a threshold;
a state in which a relative lateral movement acceleration of the other vehicle with respect to the vehicle is equal to or more than a threshold;
a state in which a relative yaw angle of the other vehicle with respect to the vehicle is equal to or more than a threshold; and
a state in which a lateral overlap rate of the other vehicle with respect to the vehicle is equal to or less than a threshold.

3. The vehicle control device according to claim 1, wherein when the control unit recognizes a stopping factor in which the other vehicle stops in the traffic lane based on the detection value, the control unit continues the following traveling control and causes the vehicle to decelerate and stop by following the other vehicle.

4. The vehicle control device according to claim 1, wherein when the other vehicle changes a route and the control unit recognizes the departure operation, and when a light display of a direction indication of the vehicle is in a lit state and the control unit determines that the vehicle travels the route by following the other vehicle, the control unit continues the following traveling control.

5. A non-transitory storage medium storing a program installed in a vehicle control device that executes a following traveling control and a constant speed traveling control, the following traveling control causing a vehicle that travels within a traffic lane to travel by following another vehicle that travels in front of the vehicle and the constant speed traveling control causing the vehicle to travel at a constant speed within the traffic lane, the program causing a computer to perform processes comprising:
executing the following traveling control that causes the vehicle to travel by following the other vehicle based on a detection value that detects the other vehicle;
determining that the other vehicle departs the traffic lane when recognizing a departure operation in which the other vehicle departs the traffic lane based on the detection value; and
executing the constant speed traveling control along with stopping the following traveling control.
